(19) United States
(12) Patent Application Publication
(10) Pub. No.: US 2014/0278945 A1
(43) Pub. Date: Sep. 18, 2014

(54) ONLINE ALLOCATION WITH MINIMUM TARGETS

(71) Applicant: MICROSOFT CORPORATION, Redmond, WA (US)

(72) Inventors: Sreenivas Gollapudi, Cupertino, CA (US); Debmalya Panigrahi, Bellevue, WA (US)

(73) Assignee: MICROSOFT CORPORATION, Redmond, WA (US)

(21) Appl. No.: 13/831,813

(22) Filed: Mar. 15, 2013

(51) Int. Cl. G06Q 30/02

(52) U.S. Cl. CPC G06Q 30/0247; G06Q 30/0275
USPC 705/14.46

(57) ABSTRACT

Various technologies described herein pertain to allocating requests based on revenue targets of providers for an online service. Information that indicates revenue budgets of providers for the online service and revenue targets of the providers for the online service can be received. The revenue budgets set maximums for total revenues from the providers and the revenue targets set minimums for the total revenues from the providers. Moreover, a request allocable to one of the providers having a total revenue generated thereby constrained by a corresponding revenue budget can be received. Further, bid values of the providers corresponding to the request can be received. An output of an algorithm can be computed based at least in part upon the bid values of the providers and the revenue targets of the providers. The request can be allocated to a selected provider from the providers based upon the output of the algorithm.

### BACKGROUND

As the Internet achieves ubiquity and web-based services become more commonplace in modern life, online systems have increasingly relied on algorithms for allocating scarce resources to competing entities. For instance, in the field of Internet advertising, many conventional online resource allocation algorithms have been developed. Such algorithms commonly attempt to assign advertising slots on dynamically generated webpages to interested advertisers (e.g., bidders) who are constrained by respective advertising budgets, such that revenue generated by the assignments is maximized.

Allocation of scarce resources to competing entities is also employed in other types of online systems. For example, another type of online system that can employ an online resource allocation algorithm is an online store (e.g., e-commerce website) that causes a set of relevant products from multiple sellers to be output (e.g., displayed) in response to a product query. Following this example, traditional online resource allocation algorithms can be evaluated to assign the sellers and the set of products output responsive to the product query, where the assignment attempts to maximize expected revenue generated due sales of the products.

### SUMMARY

Described herein are various technologies that pertain to allocating requests based on revenue targets of providers for an online service. Information that indicates revenue budgets of the providers for the online service and the revenue targets of the providers for the online service can be received. The revenue budgets set maximums for total revenues from the providers and the revenue targets set minimums for the total revenues from the providers. Thus, a request may be allocated to a provider whose revenue budget is not yet exhausted and is yet to meet her revenue target. Further, bid values of the providers corresponding to the request can be received. The bid values of the providers can also be used to allocate the request. For example, the request can be allocated to the provider that has a high bid value and also has not met her revenue target. Accordingly, an output of an algorithm can be computed based at least in part upon the bid values of the providers and the revenue targets of the providers. The request can be allocated to a selected provider from the providers based upon the output of the algorithm.

According to various embodiments, the algorithm can be a max-min algorithm. The max-min algorithm can optimize a minimum fractional coverage among fractional coverages of the providers. A fractional coverage of a particular provider is a ratio of a total revenue generated by the particular provider to a revenue target of the particular provider. According to other embodiments, the algorithm can be a hybrid algorithm, which can optimize a sum of the total revenues of the providers with penalties included for the providers that do not meet their revenue targets. Further, the total revenues of the providers can be constrained by the revenue budgets of the providers.

Examples of the online service include online advertising, an information market, and an online store. For instance, if the online service is online advertising, then the providers can be advertisers and the request can be an advertising slot (e.g., corresponding to a user query, on a webpage, available during execution of an application on a mobile device, etc.). Further, if the online service is an information market, then the providers can be data providers and the request can be a data query. Moreover, if the online service is an online store, then the providers can be sellers of products and the request can be a product query. It is to be noted, however, that other types of online services for which resources (often associated with user requests) can be allocated to providers are intended to fall within the scope of the hereto appended claims.

Further, the revenue targets of the providers of the online service can be received in one or many forms. In an instance, user input that specifies a revenue target for a particular provider can be received. Additionally or alternatively, a revenue target for a given provider can be specified by contractual agreements. In another instance, a revenue target for a particular provider can be based on fairness considerations, where the revenue target represents a minimum revenue that gives the particular provider sufficient incentive to remain in a given system for the online service.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that assigns requests to providers of an online service based on revenue targets of the providers.

FIG. 2 illustrates a functional block diagram of an exemplary system that employs a hybrid algorithm to allocate the requests to the providers.

FIG. 3 illustrates a functional block diagram of an exemplary system that allocates online advertising slots to advertisers.

FIG. 4 illustrates a functional block diagram of an exemplary system that allocates data queries for an information market.

FIG. 5 illustrates a functional block diagram from an exemplary system that allocates product queries for an online store.

FIG. 6 is a flow diagram that illustrates an exemplary methodology of allocating a request to a selected provider based on revenue targets of providers.

FIG. 7 is a flow diagram that illustrates an exemplary methodology of implementing a max-min algorithm to allocate requests to providers.

FIG. 8 is a flow diagram that illustrates an exemplary methodology of implementing a hybrid algorithm to allocate requests to providers.

FIG. 9 illustrates an exemplary computing device.

### DETAILED DESCRIPTION

Various technologies pertaining to allocating requests based on revenue targets of providers for an online service are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, requests can be allocated based on revenue targets of providers for an online service (e.g., online advertising, online store, information market, etc.). Information that indicates revenue budgets of the providers for the online service and the revenue targets of the providers for the online service can be received. The revenue budgets set maximums for total revenues from the providers and the revenue targets set minimums for the total revenues from the providers. Moreover, a request that is allocable to one of the providers having a total revenue generated thereby that is less than a corresponding revenue budget can be received. Further, bid values of the providers corresponding to the request can be received. An output of an algorithm can be computed based at least in part upon the bid values of the providers and the revenue targets of the providers. The algorithm can be a max-min algorithm or a hybrid algorithm. The request can be allocated to a selected provider from the providers based upon the output of the algorithm.

Referring now to the drawings, FIG. 1 illustrates a system 100 that assigns requests 102 to providers of an online service based on revenue targets of the providers. The system 100 includes an allocation system 104 that allocates the requests 102 to N providers, namely, a provider 1 106, . . . , and a provider N 108, where N can be substantially any integer (collectively referred to herein as providers 106-108). The providers 106-108 are bidders for the requests 102. It is contemplated that the allocation system 104 can be utilized for substantially any type of online service that arbitrates among a set of available choices (e.g., selection of the providers 106-108) in order to satisfy online demands, while addressing dual objectives pertaining to revenue and fairness as part of an arbitration protocol.

The allocation system 104 provides access to a resource (e.g., the requests 102) that is constrained. An amount of demand for the resource can exceed a supply of the resource. Accordingly, the allocation system 104 can allot the resource to the providers 106-108 in a manner that provides access based upon fairness and revenue based considerations.

The allocation system 104 includes an interface component 110 that receives information that indicates revenue budgets of the providers 106-108 for an online service. The revenue budgets set maximums for total revenues from the providers 106-108. Moreover, the interface component 110 receives revenue targets of the providers 106-108 for the online service. The revenue targets set minimums for the total revenues from the providers 106-108. The interface component 110 can further receive the requests 102. For instance, a request (e.g., from the requests 102) can be allocable to one of the providers 106-108 having a total revenue generated thereby constrained by a corresponding revenue budget (e.g., the request can be allocable to a provider whose total revenue is currently less than the corresponding revenue budget for the provider). Moreover, the interface component 110 can receive bid values of the providers 106-108 corresponding to the requests 102. For example, a request may be allocated to a provider whose revenue budget is not yet exhausted and is yet to meet her revenue target. Following this example, the request can further be allocated based upon the bid values of the providers 106-108 corresponding to the requests 102.

The allocation system 104 further includes an evaluation component 112 that computes an output of an algorithm based at least in part upon the bid values of the providers 106-108 for a request (e.g., from the requests 102) and the revenue targets of the providers 106-108. Examples of the algorithm that can be analyzed by the evaluation component 112 include a max-min algorithm and a hybrid algorithm as set forth in greater detail herein. The allocation system 104 also includes an assignment component 114 that allocates the request (e.g., allocated request(s)) to a selected provider from the providers 106-108 based upon the output of the algorithm.

The max-min algorithm can optimize a minimum fractional coverage among fractional coverages of the providers 106-108. A fractional coverage of a particular provider can be a ratio of a total revenue generated by the particular provider to a revenue target of the particular provider. An objective of the max-min algorithm can be to meet the revenue targets of the providers 106-108; while meeting the revenue targets, the max-min algorithm can maximize revenue. Moreover, the hybrid algorithm can optimize a sum of the total revenues of the providers 106-108 with penalties included for a subset of the providers 106-108 that each has a total revenue that is less than a corresponding revenue target. The total revenues of the providers are further constrained by the revenue budgets of the providers 106-108. Thus, an objective of the hybrid algorithm can be to maximize revenue, yet penalties can be introduced for the subset of the providers 106-108 whose corresponding revenue targets are unmet.

The providers 106-108 (e.g., advertisers, data providers, sellers, etc.) can each constrained by a corresponding revenue budget given offline to the allocation system 104. Further, the requests 102 (e.g., advertising slots on webpages, data queries, product queries, etc.) can arrive at the interface component 110 of the allocation system 104 online. By being online, the requests 102 are unknown in advance (e.g., the allocation system 104 allocates the requests 102 as the requests 102 appear). Each request from the request 102 can be allocated to one of the providers 106-108 by the allocation system 104. Such allocation can generate a specified amount of revenue subject to the constraint that the total revenue for a provider cannot exceed her revenue budget.

In conventional revenue maximizing scenarios, a goal of an allocation algorithm can be to maximize revenue. In contrast, the allocation system 104 supports fairness in allocation of the requests 102 to the providers 106-108. Fairness is supported by an offline parameter referred to herein as the revenue target for a provider (e.g., from the providers 106-108). The revenue target can represent a minimum revenue for the provider that gives the provider sufficient incentive to stay in the system. The online allocation algorithm analyzed by the evaluation component 112 can provide that each of the providers 106-108 meets such corresponding revenue target even at a cost of decreased overall revenue across the providers 106-108. Allocations can be made by the allocation system 104 that meet the revenue targets, while favoring allocations that generate greater revenue.

It is contemplated that the revenue targets of the providers 106-108 can be from substantially any source. According to an example, the interface component 110 can receive user input that specifies a given revenue target for a given provider. The user input, for instance, can specify a minimum threshold amount of revenue that the provider desires to spend, a minimum fraction of a revenue budget that the provider desires to spend, etc. Additionally or alternatively, a given revenue target for a given provider can be specified by a contractual agreement, for example. Following this example, the contractual agreement may specify a certain number of requests being assigned to a provider (e.g., contractual agreement between an ad exchange and an advertiser for a certain number of impressions being allotted to the advertiser, etc.). According to another example, a revenue target for a particular provider can be based on fairness considerations, where the revenue target represents a minimum revenue that gives the particular provider sufficient incentive to remain in a given system for the online service. It is to be appreciated, however, that the claimed subject matter is not limited to the foregoing examples, and instead it is contemplated that a given revenue target for a given provider can be calculated, inferred, determined, etc. from substantially any other information. Moreover, the allocation techniques set forth herein are agnostic as to the source of the revenue targets for the providers 106-108.

Let D be a set of N providers 106-108. Let B, and Tᵢ be the revenue budget and the revenue target respectively for provider iεD, where Tᵢ≦Bᵢ. An input set Q of m requests 102 arrives online at the interface component 110, where each request jεQ has a bid value bᵢⱼ corresponding to each provider iεD. For instance, some of the bid values can be 0; yet, the claimed subject matter is not so limited. It can be assumed that the requests 102 are independently and identically distributed (i.i.d.) according to some probability distribution that is unknown to the algorithm. On the arrival of request j, the algorithm allocates it to a provider (denoted d(j)). Let Q(i) be a set of requests that are allocated to provider i. Unrestricted revenue Rᵢ generated by provider iεD is given by Σ_{jεQ(i)}bᵢⱼ, while a budgeted revenue (or revenue) P, generated by provider iεD is given by min(Rᵢ, Bᵢ). A fractional coverage cᵢ for provider iεD is given by the ratio

$$\frac{{P}_{i}}{{T}_{i}} .$$

As noted herein, the evaluation component 112 can employ a max-min algorithm or a hybrid algorithm. The max-min algorithm can have differing objectives as compared to the hybrid algorithm. For instance, the max-min algorithm can have a goal to maximize a minimum fractional coverage (e.g., min_{iεD}cᵢ). In contrast, the hybrid algorithm can seek to maximize a total revenue while penalizing providers 106-108 whose revenues are less than corresponding revenue targets. More particularly, a penalty coefficient α can be used in the hybrid algorithm to maximize Σ_{iεD}(Pᵢ−α max(Tᵢ−Pᵢ, 0)).

In contrast to the max-min algorithm and the hybrid algorithm, conventional approaches oftentimes employ a max-sum algorithm that maximizes a total budgeted revenue (e.g., Σ_{iεD}Pᵢ). The max-sum algorithm, however, fails to take into account revenue targets of the providers 106-108. As compared to the max-sum algorithm, the max-min algorithm and the hybrid algorithm can allocate the requests 102 based upon fairness considerations (e.g., as a function of revenue targets of the providers 106-108). Moreover, the max-min algorithm and the hybrid algorithm can result in increased revenues as compared to the max-sum algorithm; yet, the claimed subject matter is not so limited.

The max-min algorithm is now described in greater detail. The evaluation component 112 can compute the output of the max-min algorithm based at least in part upon the bid values of the providers 106-108 and the revenue targets of the providers 106-108 by calculating rewards for the providers 106-108 based upon a reward function. According to an example, the reward function can exponentially decay depending upon the fractional coverages of the providers 106-108 and polynomially increase depending upon the bid values of the providers 106-108. The rewards can be proportional to the bid values of the providers 106-108 and inversely proportional to fractional coverages of the providers 106-108. A reward for a particular provider can be a decrease in a remaining reward value for the particular provider if the request is allocated to the particular provider. Moreover, the evaluation component 112 can identify a maximum reward from the rewards as calculated. The assignment component 114 can allocate the request to the selected provider associated with the maximum reward.

The reward function φ can be defined as

$$φ ( k ) = {n}^{( - \frac{k}{n} ln n - 1 )} .$$

Moreover, Φ̅(k)=∫ⱼ₌ₖ^{∞} can be defined. At a given stage of the max-min algorithm, a remaining reward for a provider i is Φ̅ᵢ= Φ̅(cᵢ). Assuming j is a current request, a reward rᵢⱼ can be defined as a decrease in a value of Φ̅ᵢ if the request j is allocated to the provider i. Thus, the max-min algorithm can be employed by the allocation system 104 to allocate the current request j to the provider that maximizes rᵢⱼ. For instance, the request j can be allocated to the provider iεDⱼ that maximizes rᵢⱼ, where rᵢⱼ=∫_{k=c}_{ᵢ}^{c}^{ᵢ}^{+b}_{^{ij}}^{/T}^{ᵢ}φ(k).

With reference to FIG. 2, illustrated is a system 200 that employs the hybrid algorithm to allocate the requests 102 to the providers 106-108. Again, the system 200 includes the allocation system 104, which further comprises the interface component 110, the evaluation component 112, and the assignment component 114.

The evaluation component 112 computes the output of the hybrid algorithm based at least in part upon the bid values of the providers 106-108 for a request (e.g., from the requests 102) and the revenue targets of the providers 106-108. The hybrid algorithm can optimize a sum of the total revenues of the providers 106-108 with penalties included for the subset of the providers 106-108 that each has a total revenue that is less than a corresponding revenue target. As noted above, the evaluation component 112 can employ the hybrid algorithm to maximize Σ_{iεD}(Pᵢ−β max(Tᵢ−Pᵢ, 0)).

Consider a linear program (LP) relaxation of the hybrid problem as set forth below (e.g., a primal LP).

Maximize Σ_{jεQ}Σ_{iεD}bᵢⱼxᵢⱼ−αΣ_{iεD}πᵢ subject to

Σ_{iεD}xᵢⱼ≦1 for all jεQ

Σ_{jεQ}bᵢⱼxᵢⱼ≦Bᵢ for all iεD

πᵢ≧Tᵢ−Σ_{jεQ}bᵢⱼxᵢⱼ for all iεD

xᵢⱼ≧0 for all iεD, jεQ

πᵢ≧0 for all iεD

Here, xᵢⱼ is a fraction of request j that is allocated to provider i, and απᵢ is a penalty paid by provider i. A dual LP of the primal LP is set forth below.

Minimize Σ_{jεQ}yᵢ+Σ_{iεD}(zᵢBᵢ−wᵢTᵢ) subject to

yᵢ≧bᵢⱼ(1−zᵢ+wᵢ) for all iεD, jεQ

wᵢ≦α for all iεD

yⱼ≧0 for all jεQ

zᵢ,wᵢ≧0 for all iεD

The hybrid algorithm can be a two phase algorithm. The evaluation component 112 can include an initialization component 202 that solves the dual LP to determine dual LP variable values based upon a first fraction ε of the requests 102. For the first fraction ε of the requests 102, the hybrid algorithm can solve the dual LP with Bᵢ and Tᵢ replaced by εBᵢ and εTᵢ, respectively. The resulting dual LP variable values determined by the initialization component 202 are zᵢ* and wᵢ*. Accordingly, the initialization component 202 can determine the dual LP variable values based upon the revenue targets of the providers 106-108 and the revenue budgets of the providers 106-108 for a limited observation set.

The dual LP variable values determined by the initialization component 202 can be utilized by the evaluation component 112 for a remainder of the requests 102, where the remainder of the requests 102 is subsequent to the first fraction of the requests 102. According to an example, the first fraction of the requests 102 can be less than or equal to a first 1 percent of the requests 102; however, the claimed subject matter is not so limited.

Moreover, the evaluation component 112 can calculate values for the providers 106-108 as a function of the bid values of the providers 106-108 and the dual LP variable values computed by the initialization component 202. Complimentary slackness can be used to employ the dual LP variable values computed by the initialization component 202 in the primal LP. According to an example, for subsequently arriving requests (e.g., after the first fraction of the requests 102), the evaluation component 112 can identify a provider that satisfies arg max_{iεD}bᵢⱼ(1−zᵢ*+wᵢ*). Thus, the evaluation component 112 can identify a maximum value from the values as calculated. Moreover, the assignment component 114 can allocate the request to the selected provider associated with the maximum value.

Turning to FIG. 3, illustrated is a system 300 that allocates online advertising slots to advertisers. The system 300 includes an ad exchange 302, which can further include a computing device 304 (e.g., a server). The computing device 304 includes the allocation system 104 and a data repository 306. The allocation system 104 allocates advertising slots to N advertisers, namely, an advertiser 1 308, . . . , and an advertiser N 310, where N can be substantially any integer (collectively referred to herein as advertisers 308-310). The advertising slots, for instance, can correspond to a user query, can be available during execution of an application on a mobile device, etc.

The data repository 306 includes revenue budgets 312 of the advertisers 308-310. Moreover, the data repository 306 includes revenue targets 314 of the advertisers 308-310. Further, the data repository 306 includes bid values 316 of the advertisers 308-310 for the advertising slots.

According to the example shown in FIG. 3, the online service can be online advertising. Thus, the providers (e.g., the providers 106-108 of FIGS. 1-2) are the advertisers 308-310, and the requests (e.g., the requests 102 of FIGS. 1-2) are advertising slots. The allocation system 104 can assign the advertising slots on dynamically generated webpages to the advertisers 308-310, where the advertisers 308-310 are constrained by respective revenue budgets 312. Moreover, the allocation system 104 can allocate the advertising slots to the advertisers 308-310 based upon the revenue targets 314 of the advertisers 308-310. To effectuate the allocation of the advertising slots, the allocation system 104 can employ the max-min algorithm or the hybrid algorithm as described herein.

By way of an example, the ad exchange 302 can receive a request for an advertisement to display during an advertising slot from an ad server (not shown); however, the claimed subject matter is not so limited. Moreover, while not shown, it is contemplated that the advertisers 308-310 can communicate with ad network(s), and the ad network(s) can be in communication with the ad exchange 302; yet, the claimed subject matter is not so limited. Moreover, responsive to the allocation of the advertising slots to the advertisers 308-310, advertisements for the advertising slots can be output by the ad exchange 302.

With reference to FIG. 4, illustrated is a system 400 that allocates data queries for an information market. The system 400 includes a server 402 and N data providers, namely, a data provider 1 404, . . . , and a data provider N 406, where N can be substantially any integer (collectively referred to herein as data providers 404-406). The server 402 further includes the allocation system 104 and the data repository 306. The data repository 306 further includes the revenue budgets 312 of the data providers 404-406, the revenue targets 314 of the data providers 404-406, and the bid values 316 of the data providers 404-406 for data queries.

According to the example set forth in FIG. 4, the online service is an information market. Thus, the providers (e.g., the providers 106-108 of FIGS. 1-2) are the data providers 404-406. Moreover, the requests (e.g., the requests 102 of FIGS. 1-2) are data queries.

In a data and information market, the allocation system 104 can allocate data queries to the data providers 404-406. The data providers 404-406 can sell raw data or services utilizing user generated data in the data and information market. In such market, the data queries (e.g., queries received from users) can seek specific information or datasets. The data queries can be redirected by the allocation system 104 to one among the set of data providers 404-406 who is was capable of providing such information responsive to the data queries. The allocation system 104 can employ the max-min algorithm or the hybrid algorithm to fairly allocate the data queries to the data providers 404-406 so as to mitigate one or more of the data providers 404-406 from being starved of data queries.

With reference to FIG. 5, illustrated is a system 500 that allocates product queries for an online store. The system 500 includes a server 502 and a plurality of sellers, namely, a seller 1 504, . . . , and a seller N 506, where N can be substantially any integer (collectively referred to herein as sellers 504-506). Moreover, the server 502 includes the allocation system 104 and the data repository 306. The data repository 306 further includes the revenue budgets 312 of the sellers 504-506, the revenue targets 314 of the sellers 504-506, and the bid values 316 of the sellers 504-506 for the product queries.

The online service supported by the server 502 is an online store. According to the example set forth in FIG. 5, the providers (e.g., the providers 106-108 of FIGS. 1-2) are the sellers 504-506 of products. Moreover, the requests (e.g., the requests 102 of FIGS. 1-2) are product queries.

Accordingly, the online store (e.g., e-commerce website) can show a set of relevant products from multiple sellers 504-506 in response to a product query. The set of products displayed and the corresponding sellers 504-506 chosen by the allocation system 104 can be allocated based on expected revenue generated due to sales while meeting the revenue targets 314 for the sellers 504-506 to mitigate one or more of the sellers 504-506 from leaving the portal in the long run. Similar to above, the allocation system 104 can employ the max-min algorithm or the hybrid algorithm as described herein.

FIGS. 6-8 illustrate exemplary methodologies relating to allocating requests to providers of an online service based upon revenue targets of the providers. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 6 illustrates a methodology 600 of allocating a request to a selected provider based on revenue targets of providers. At 602, information that indicates revenue budgets of the providers for an online service and revenue targets of the providers for the online service can be received. At 604, a request that is allocable to one of the providers having a total revenue generated thereby constrained by a corresponding revenue budget can be received. At 606, bid values of the providers corresponding to the request can be received. At 608, an output of an algorithm can be computed based at least in part upon the bid values of the providers and the revenue targets of the providers. The algorithm, for example, can be a max-min algorithm or a hybrid algorithm. At 610, the request can be allocated to a selected provider from the providers based upon the output of the algorithm.

Turning to FIG. 7, illustrated is a methodology 700 of implementing a max-min algorithm to allocate requests to providers. At 702, rewards for providers can be calculated based upon a reward function. The rewards can be proportional to bid values of the providers and inversely proportional to fractional coverages of the providers. Moreover, a reward for a particular provider can be a decrease in a remaining reward value for the particular provider if the request is allocated to the particular provider. At 704, a maximum reward from the rewards as calculated can be identified. At 706, a request can be allocated to a selected provider associated with the maximum reward.

With reference to FIG. 8, illustrated is a methodology 800 of implementing a hybrid algorithm to allocate requests to providers. At 802, a dual linear program (LP) can be solved to determine dual LP variable values based upon a first fraction of requests. At 804, values for providers can be calculated as a function of bid values of the providers and the dual LP variable values as previously computed for a remainder of the requests. At 806, maximum values from the values as calculated for the remainder of the requests can be identified. At 808, the remainder of the requests can be allocated to selected providers associated with the maximum values for each of the requests.

Referring now to FIG. 9, a high-level illustration of an exemplary computing device 900 that can be used in accordance with the systems and methodologies disclosed herein is illustrated. For instance, the computing device 900 may be used in a system that allocates requests based on revenue targets of providers for an online service. By way of example, the computing device 900 can be used to allocate requests to providers for an online service such as online advertising, an online store, or an information market. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store revenue budgets, revenue targets, bid values, and so forth.

The computing device 900 additionally includes a data store 908 that is accessible by the processor 902 by way of the system bus 906. The data store 908 may include executable instructions, revenue budgets, revenue targets, bid values, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method that is executed by a computer processor on a computing device, the method comprising:
receiving information that indicates revenue budgets of providers for an online service and revenue targets of the providers for the online service, wherein the revenue budgets set maximums for total revenues from the providers, and wherein the revenue targets set minimums for the total revenues from the providers;
receiving a request allocable to one of the providers having a total revenue generated thereby constrained by a corresponding revenue budget;
receiving bid values of the providers corresponding to the request;
computing an output of an algorithm based at least in part upon the bid values of the providers and the revenue targets of the providers; and
allocating the request to a selected provider from the providers based upon the output of the algorithm.

2. The method of claim 1, wherein the algorithm optimizes a minimum fractional coverage among fractional coverages of the providers, wherein a fractional coverage of a particular provider is a ratio of a total revenue generated by the particular provider to a revenue target of the particular provider.

3. The method of claim 1, wherein computing the output of the algorithm based at least in part upon the bid values of the providers and the revenue targets of the providers further comprises:
calculating rewards for the providers based upon a reward function, wherein the rewards are proportional to the bid values of the providers and inversely proportional to fractional coverages of the providers, wherein a fractional coverage of a particular provider is a ratio of a total revenue generated by the particular provider to a revenue target of the particular provider, and wherein a reward for the particular provider is a decrease in a remaining reward value for the particular provider if the request is allocated to the particular provider; and
identifying a maximum reward from the rewards as calculated, wherein the request is allocated to the selected provider associated with the maximum reward.

4. The method of claim 3, wherein the reward function exponentially decays depending upon the fractional coverages of the providers and polynomially increases depending upon the bid values of the providers.

5. The method of claim 1, wherein the algorithm optimizes a sum of the total revenues of the providers with penalties included for a subset of the providers that each has a total revenue that is less than a corresponding revenue target, wherein the total revenues of the providers are constrained by the revenue budgets of the providers.

6. The method of claim 1, wherein computing the output of the algorithm based at least in part upon the bid values of the providers and the revenue targets of the providers further comprises:
calculating values for the providers as a function of the bid values of the providers and previously computed dual linear program (LP) variable values, wherein the previously computed dual LP variable values are determined based upon the revenue targets of the providers and the revenue budgets of the providers; and
identifying a maximum value from the values as calculated, wherein the request is allocated to the selected provider associated with the maximum value.

7. The method of claim 6, further comprising solving a dual LP to determine dual LP variable values based upon a first fraction of requests, wherein the dual LP variable values are utilized as the previously computed dual LP variable values for a remainder of the requests, and wherein the remainder of the requests are subsequent to the first fraction of the requests.

8. The method of claim 7, wherein the first fraction of the requests is less than or equal to a first 1 percent of the requests.

9. The method of claim 1, wherein the online service is online advertising, the providers are advertisers, and the request is an advertising slot.

10. The method of claim 1, wherein the online service is an information market, the providers are data providers, and the request is a data query.

11. The method of claim 1, wherein the online service is an online store, the providers are sellers of products, and the request is a product query.

12. The method of claim 1, further comprising receiving user input that specifies a given revenue target for a given provider.

13. The method of claim 1, wherein a given revenue target for a given provider is specified by a contractual agreement.

14. A system that facilitates allocating advertising slots, comprising:
a processor; and
a memory that comprises a plurality of components that are executed by the processor, the plurality of components comprising:
an interface component that receives information that indicates revenue budgets of advertisers for online advertising, revenue targets of the advertisers for the online advertising, an advertising slot allocable to one of the advertisers having a total revenue generated thereby less than a corresponding revenue budget, and bid values of the advertisers corresponding to the advertising slot, wherein the revenue budgets set maximums for total revenues from the advertisers, and wherein the revenue targets set minimums for the total revenues from the advertisers;
an evaluation component that computes an output of an algorithm based at least in part upon the bid values of the advertisers and the revenue targets of the advertisers; and
an assignment component that allocates the advertising slot to a selected advertiser from the advertisers based upon the output of the algorithm.

15. The system of claim 14 comprised in a computing device of an ad exchange.

16. The system of claim 14, wherein the evaluation component computes rewards for the advertisers based upon a reward function and identifies a maximum reward from the rewards as computed, wherein the reward function exponentially decays depending upon fractional coverages of the advertisers and polynomially increases depending upon the bid values of the advertisers, wherein a fractional coverage of a particular advertiser is a ratio of a total revenue generated by the particular advertiser to a revenue target of the particular advertisers, wherein a reward for the particular advertiser is a decrease in a remaining reward value for the particular advertiser if the advertising slot is allocated to the particular advertiser, and wherein the assignment component allocates the advertising slot to the selected advertiser associated with the maximum reward.

17. The system of claim 14, wherein the evaluation component computes values for the advertisers as a function of the bid values of the advertisers and previously computed dual linear program (LP) variable values, and identifies a maximum value from the values as computed, wherein the previously computed dual LP variable values are determined based upon the revenue targets of the advertisers and the revenue budgets of the advertisers, and wherein the assignment component allocates the advertising slot to the selected advertiser associated with the maximum value.

18. The system of claim 17, wherein the evaluation component further comprises an initialization component that solves a dual LP to determine dual LP variable values based upon a first fraction of advertising slots, wherein the dual LP variable values are utilized as the previously computed dual LP variable values for a remainder of the advertising slots, and wherein the remainder of the advertising slots are subsequent to the first fraction of the advertising slots.

19. The system of claim 14, wherein the interface component receives user input that specifies a given revenue target for a given advertiser.

20. A computer-readable storage medium including computer-executable instructions that, when executed by a processor, cause the processor to perform acts including:
receiving user input that specifies revenue budgets of providers for an online service and revenue targets of the providers for the online service, wherein the revenue budgets set maximums for total revenues from the providers, and wherein the revenue targets set minimums for the total revenues from the providers;
receiving a request allocable to one of the providers having a total revenue generated thereby less than a corresponding revenue budget;
receiving bid values of the providers corresponding to the request; and
allocating the request to a selected provider chosen from the providers based upon an output of an algorithm computed based at least in part upon the bid values of the providers and the revenue targets of the providers.
